(19) United States
(12) Patent Application Publication
(10) Pub. No.: US 2009/0270305 A1
(43) Pub. Date: Oct. 29, 2009

(54) CLEANING COMPOSITION

(76) Inventor: Mitchell T. Johnson, Gig Harbor, WA (US)

Correspondence Address: 3M INNOVATIVE PROPERTIES COMPANY, PO BOX 33427, ST. PAUL, MN, 55133-3427, US

(21) Appl. No.: 12/302,541

(22) PCT Filed: May 15, 2007
(86) PCT No.: PCT/US2007/068920

§ 371 Date: Jul. 9, 2009

Related U.S. Application Data
(60) Provisional application No. 60/803,693, filed on Jun. 1, 2006.

(51) Int. Cl. C11D 1/825

(52) U.S. Cl. 510/433; 510/470

(57) ABSTRACT

Multi-surface cleaning compositions and methods of use. Compositions have a combination of an alkyl polyglucoside and pyrrolidone, present in an actives ratio of at least 2:1, sometimes at least 5:1. A composition concentrate can be diluted with water, at a ratio of 1:800 or even 1:900, to form an acceptable use-composition.

### FIELD OF THE DISCLOSURE

The present disclosure is directed to low odor, biodegradable cleaning compositions, including cleaning concentrates and use-compositions.

### BACKGROUND

Cleaning compositions are used daily at numerous residential, industrial and institutional locales to clean various surfaces. The ultimate goal of a cleaning composition is to effectively remove any or all of dirt, grime, dust, greasy residues, etc. from a surface while not leaving significant residue or streaks on the surface.

In general, the user wishes to achieve the fastest cleaning, with the least streaking on hard surfaces, with the least amount of composition. Also desired is a composition which is easy to use, easy to be disposed, and which does not have adverse effects on the user or the environment.

### SUMMARY OF THE DISCLOSURE

The present disclosure is directed to cleaning compositions, both concentrate and use-compositions, and methods of their use. Compositions are described which are useful in removing grease, heel marks, and the like from hard surfaces without streaking. Further, the compositions may have other uses such as removing food soils, grease, and the like from surfaces.

The compositions of the present disclosure include combinations of an alkyl polyglucoside and an alkyl pyrrolidone, present in a molar ratio of at least 5:1. A composition concentration, having an actives level of about 20 wt-%, can be diluted at a level of at least 1:400, even as much as 1:800 or even as much as 1:900, with solvent to form a suitable use-composition.

In one aspect, the disclosure is to a neutral cleaning composition including an alkyl glucoside and an alkyl pyrrolidone, present at an actives ratio of at least about 2:1.

In another aspect the disclosure is to a cleaning use-composition including less than about 1% by weight of an alkyl glucoside and an alkyl pyrrolidone, the alkyl glucoside and alkyl pyrrolidone being present at an actives ratio of at least about 2:1.

In yet another aspect the disclosure is to a method of cleaning a surface including the steps of providing a composition concentrate including an alkyl glucoside and an alkyl pyrrolidone, present at an actives ratio of at least about 2:1, diluting the composition concentrate with water by at least 1:10 to provide a use composition, and applying the use-composition to the surface.

These and other embodiments and aspects are within the scope of this disclosure.

### DETAILED DESCRIPTION

The present disclosure relates to a cleaning composition formulated to clean residential, industrial and institutional surfaces such as counter tops, floors, walls, and the like without streaking and/or hazing or leaving an undesired residue. The phrase “non-streaking” and variations thereof means there is essentially no residue apparent to the human eye under a standard light source. The phrase “non-hazing” or “no haze” and variations thereof means that there is essentially no opacity, apparent to the human eye under a standard light source, on the cleansed surface. The compositions may have other uses such as removal of dirt, grease, stains, and the like from other surfaces.

The compositions may be in the form of a “concentrate”, a “use solution”, or other forms. Typically the compositions are in liquid form, although in some embodiments, the compositions could be a solid material, which would typically be in concentrated form.

When the term “composition” is used herein, it is intended to refer to either or both the concentrate or the use-composition, unless indicated otherwise. For example, when ratios of ingredients are provided, these ratios would typically apply to both the concentrate and the use-composition. Conversely, for example, a weight percentage of active ingredient(s) would typically be given specifically for the concentrate or a specific end use-composition.

The compositions can be provided as a concentrate for shipment to retail distributors or commercial or residential end users. It is expected that the end user, either the commercial or residential user, will dilute the concentrate, such as in a tank or a bucket, to provide a use-composition. It is expected that commercial end users, such as industrial locales, will dilute the concentrate in large volumes in tanks, such as 1000 gallons, to achieve a use-composition and then use the use-composition as part of their cleaning service. It is expected that residential end users, such as individual persons, will dilute the concentrate in a bucket from a garden hose or tap to achieve a use-composition. Examples of particularly well suited methods of dilution are a Venturi siphon system or the Twist'n Fill™ system based on gravity feed, available from 3M Company.

The compositions of this disclosure include a combination of an alkyl polyglucoside and alkyl pyrrolidone, present in an actives weight ratio of at least 2:1. It was found that the combination of these two ingredients, at this level, provide compositions that are greatly improved over prior compositions. In one aspect, with these compositions, the active ingredients are present at very low levels in the use-composition.

As used herein the term “active” or “active ingredient” means the ingredient alone or in combination has an effect on the cleaning and/or non-streaking ability of the composition. The active ingredients for the compositions of the present disclosure are alkyl polyglucoside and alkyl pyrrolidone. In contrast, “inactive” means the component is added primarily for aesthetic purposes, such as odor, color, and the like, or is an ingredient other than an alkyl polyglucoside or an alkyl pyrrolidone.

The alkyl polyglucoside suitable for use in the compositions is typically a C6-C18 alkyl polyglucoside, preferably a C10-C16 alkyl polyglucoside. It should be understood that these ranges are not limiting and that any alkyl polyglucosides are generally suitable. For example, one preferred material for the compositions is coco glucoside, which in some sources is listed as being a combination of C6-C16 molecules, although at least one other source states it is a combination of C6-C18 molecules.

There are numerous commercial sources of alkyl polyglucosides. Pure alkyl polyglucosides and blends with multiple alkyl polyglucosides or with other ingredients are available from, for example, Akzo Nobel, Cognis Corp., Rhone-Poulenc, and Rhodia Novecare.

In the composition, the alkyl polyglucoside typically acts as surfactant, emulsifying or otherwise acting to lift and/or suspend dirt.

The alkyl pyrrolidone suitable for use in the composition is typically a pyrrolidone being C8 and higher, typically C8-C10. As used herein, the terms “pyrrolidone”, “pyrrolidinone”, “pyrrolidon”, “pyrrolidinon” are used interchangeably.

There are numerous commercial sources of alkyl pyrrolidone, both as pure alkyl pyrrolidone and blends. For example, the product available from International Specialty Products (ISP) under the trade designation “LP 100” includes N-octyl-2-pyrrolidone. Also available from ISP are a C8 pyrrolidone under the trade designation “LP100” and a C10 pyrrolidone under the trade designation “LP200”. There are various other alkyl pyrrolidone commercial sources.

The pyrrolidone typically acts as a wetting agent, reducing the surface tension of the composition when in solution.

As stated above, the present composition includes an alkyl polyglucoside and an alkyl pyrrolidone, present in an actives weight ratio of at least 2:1. Preferably, the alkyl polyglucoside and alkyl pyrrolidone are present in an actives weight ratio of 3:1 to 6:1, more preferably about 4:1 to 5:1. As the amount of alkyl pyrrolidone in relation to the alkyl polyglucoside decreases, the composition has generally poorer wetting characteristics and has a tendency to bead. A ratio of about 4.5:1 is the preferred ratio for some compositions, whereas a ratio of about 5:1 is preferred for other compositions.

The composition is a neutral composition, meaning, it has a pH of 5 to 9. In some embodiments, a pH adjuster (e.g., acids or bases) may be added to the composition to obtain the desired neutral pH. In some embodiments, the active ingredients of the composition (i.e., the alkyl polyglucoside and the alkyl pyrrolidone) in water have a sufficiently neutral pH.

In addition to the alkyl polyglucoside and alkyl pyrrolidone, other ingredients can be added to this composition. Typically, water or other suitable solvent is present in the composition as a carrier for the alkyl polyglucoside and alkyl pyrrolidone.

Although not preferred, the composition may include other inactive ingredients such as builder(s), defoamer(s) emulsifier(s), fragrance(s), pigment(s) or dye(s), surfactant(s), chelating agent(s), sequestrant(s), hydrotrope(s) or other compatibilizer(s), processing aid(s), preservative(s), disinfectant(s) and/or anti-microbial(s), and the like. These adjuvants are known in the art of cleaning compositions.

The composition, particularly the use-composition, is generally free of any malodorous scents detectable by humans. That is, it is “low odor”. Preferably, the use-composition is generally free of any malodorous scents detectable by humans. Of course it is understood that fragrance could be added to the use-composition to make a pleasant odor.

The composition is preferably at least essentially free of any or all solvents or neutralizing compounds that contain amines, glycol ethers, ketones, esters, and alcohols, which are often sources of odors. In some embodiments, the concentrate composition has no more than 10 wt-% of these ingredients. Preferably the concentrate has no more than 5 wt-% of any one of these ingredients, more preferably no more than 1 wt-% of these ingredients. In other embodiments, the use-composition has no more than 1 wt-% of these ingredients. In preferred embodiments, whether a concentrate or use-composition, the composition has no solvents or neutralizing compounds that contain amines, glycol ethers, ketones, esters, or alcohols.

Further, the composition preferably meets Green Seal standards for performance, toxicity, and biodegradability.

The composition concentrate contains the alkyl polyglucoside and alkyl pyrrolidone, and generally some amount of water. The amount of actives, i.e., the alkyl polyglucoside and alkyl pyrrolidone, is at least 10 wt-%. In many embodiments, the amount of actives is less than 60 wt-%. In most embodiments, the amount of actives is about 15-60 wt-% actives. For some compositions, a preferred level of actives is about 20-30 wt-%, including about 25 wt-%.

The concentrate can be provided as a solid, paste or as a liquid. The solid concentrate can be in the form of a molded product of a fixed shape (e.g., tablet), powder, agglomerate, or pellets. The solid concentrate can be dispensed in a variety of dispensers known to the art, added directly to water for dilution, or contained in a water-soluble packaging which can be added to water for dilution. When the concentrate is provided as a liquid, it can be provided in a form that is readily flowable so that it can be poured or pumped or otherwise transferred.

By providing the composition as a concentrate, it is expected that the concentrate will be diluted with solvent, generally water, to form the use-composition.

After dilution of the concentrate, the resulting use-composition contains the alkyl polyglucoside, alkyl pyrrolidone, and generally a large amount of solvent, typically water. The amount of actives, i.e., the alkyl polyglucoside and alkyl pyrrolidone, is usually no more than about 1 wt % in the use-composition. In many embodiments, the amount of actives is less than about 0.5%. In most embodiments, the amount of actives is less than about 0.2%, less than about 0.1 wt-%, or even less than about 0.04 wt-% actives. It is the active ingredients, i.e., alkyl polyglucoside and alkyl pyrrolidone, provided at the disclosed ratios, that allow such low levels of active ingredients in the use-composition while obtaining suitable cleaning properties.

Because very low levels of active ingredients are needed to obtain suitable cleaning properties, the composition concentrate can be diluted with much more solvent than known cleaning compositions. The composition concentrate is typically diluted with water. A use-composition is prepared by combining 1 part composition concentrate with at least 100 parts solvent (typically water), and often with at least 200 parts solvent. For example, a composition concentrate according to this invention, having an active solids level of about 40%, can be diluted to, for example, 1:900 with water.

The dilution of the concentrate to form the use-composition can be done as a batch process at the point-of-use, in a pail, tank or vat. The concentrate could be diluted in stages to eventually provide a use-composition, for example, a first dilution (for example, 1:100) at a distribution location, and then a second dilution (for example 1:8, providing an overall dilution of 1:800) at the point-of-use. In other embodiments, the dilution is a continuous process, with the concentrate being continuously mixed with solvent as the resulting use-mixture is applied to a surface.

Generally, the use-composition is applied directly to a surface to be cleaned, although in some embodiments, the use-composition may be applied to a transfer article, such as a sponge, which is then applied to the surface.

The surface on which the composition, usually the use-composition, is applied can be any suitable surface, but is usually a hard surface. Examples of surfaces include, but are not limited to, counters, cabinets, appliance surfaces, flooring, driveways and sidewalks, siding or other construction surfaces, glass and mirrors, ceramic, tile, and the like. Examples of counters materials include laminate, granite, marble, artificial stone (such as “Cambria” stone), solid surfaces (such as “Corian” surfaces), concrete, soap stone, or stainless steel. Examples of cabinet materials include solid wood or veneer. Appliances may be enamel or stainless steel. Floors may be wood, vinyl, laminate, ceramic tile, concrete or composites. Examples of other materials that could be cleaned with the composition include porcelain, concrete and asphalt. It is understood that other surfaces and/or materials could be cleaned with the composition.

To cleanse the surface, the composition, usually the use-composition, is applied to the surface or a transfer article, either by spraying as an aerosol or non-aerosol, pouring, mopping, or the like. A scrubbing machine, which automatically dispenses the composition, could be used. Spraying can be by conventional mechanical spraying devices (such as by use of a conventional trigger spray device) or by using an aerosol dispensing container having a sufficient amount of suitable aerosol propellant.

After applying the composition to the surface to be cleaned, the composition may simply be wiped away, and with it, the dirt, food or other soil by using a nonabrasive, preferably absorbent material. Alternately, the surface may be scrubbed with an abrasive or nonabrasive article, such as a sponge or a lofty, open, three-dimensional nonwoven abrasive article, as are well known, and then wiped dry with a non-abrasive material.

### EXAMPLES

The invention is further illustrated in the following illustrative examples, in which all parts and percentages are by weight unless otherwise indicated. The following abbreviations represent the listed ingredients in the examples:

TABLE 1

| Ingredients | Source/Description |
|---|---|
| Surfactants | |
| DEHYPOUND ST | Cognis - Care Chemicals. non-ionic defoaming |
| 15 | surfactant. |
| DEHYPOUND | Cognis - Care Chemicals. No-Volatile Organic |
| HSC 5515 | Compound (NO-VOC) high performance, low |
| | foaming, surfactant blend. |
| STARFACTANT | Cognis - Coatings & Inks. hyper-branched star |
| 20 | shaped polymers based on fatty alcohol |
| | ethoxylates. |
| PLANTAREN | Cognis - Care Chemicals. Alkylpolyglucoside |
| 2000N UP | nonionic surfactant. |
| STANDAPOL ES-2 | Cognis - Care Chemicals. INCI: Sodium Laureth-2 |
| | Sulfate. |
| STEPANOL AEM | Stepan. Ammonium Laureth Sulfate & Cocamide MEA |
| TRITON CF-32 | Union Carbide. Alkylaminopolyethoxy- |
| | polypropoxyprpanol. |
| TRITON X-35 | Union Carbide. Octylphenoxypolyethoxyethanol |
| TRITON CF-76 | Union Carbide. 4-nonylphenoxy polyethoxy |
| | polypropoxy ethyl acetal |
| TRITON DF-12 | Union Carbide. |
| RHODOCLEAN | Rhone-Poulenc, Inc. Detergent and Personal Care. |
| ASP | |
| MIRATAINE CBS | Rhodia. Cocamidopropyl Hydroxy Sultaine |
| MIRATAINE CB/M | Rhodia. |
| MIRATAINE H2C- | Rhodia. Biodegradable Sodium |
| HA | Lauriminodipropionate (30%). |
| EMPICOL ESA/A2 | Rhodia. |
| MIRANOL FBS | Rhodia. Disodium cocoampho dipropionate |
| MIRACARE MHT | Rhodia. Sodium lauroamphodiacetate, Trideceth-3 |
| | sulfate salt with an amphoteric surfactant |
| MIRACARE BC-10 | Rhodia. PEG-80 sorbitan laurate cocamidopropyl |
| | betaine, sodium tricedeth sulfate |
| MIRACARE BC-20 | Rhodia. PEG-80 sorbitan laurate cocamidopropyl |
| | betaine, sodium tricedeth sulfate |
| MIRANOL Ultra C-32 | Rhodia. Sodium Cocoamphoacetate |
| MIRACARE | Rhodia. Disodium cocoamphodiacetate |
| 2MCAS | |
| RHODAPON LCP | Rhodia. Sodium Lauryl Sulfate |
| RHODAMOX LO | Rhodia. Biodegradable Lauramine oxide |
| MIRACARE MS-2 | Rhodia. |
| MIRACARE MP35 | Rhodia. sodium laureth sulfate, cocamide DEA, |
| | cocamidopropyl betaine, citric acid |
| MIRATAINE BET- | Rhodia. Cocamidopropyl Betaine |
| 0 30 | |
| MIRAPOL SURF- | Rhodia. |
| S110 | |
| TOMADOL 1-7 | Tomah Products. 1-7 Alcohol Ethoxylate is |
| | nonionic surfactant made from linear C11 alcohol |
| | with 7 moles (average) of ethylene oxide. |
| TWEEN 20 | ICI Surfactants. Known generically as Polysorbate |
| | 20. |
| BARLOX 12 | Lonza Chemical Company. Dodecyl amine oxide. |
| GLUCOPON 425 | Cognis. includes a mixture of alkyl polyglycosides |
| | and cocoglucosides. |
| RHODACAL LDS-22 | Rhone-Poulenc, Inc. Sodium Dodedcylbenzene |
| | sulfonate. |
| MIRAPON EXCEL 825 | Rhodia. |
| Solvents: | |
| SURFADON LP- | ISP Technologies. (N-octyl pyrrolidone). |
| 100 | |
| Hexyl Carbitol | Union Carbide. di(ethylenegycol)hexyl ether. |
| DOWANOL DPM | Sigma-Aldrich Chemical Company. Di(propylene |
| | glycol) Methyl Ether. |
| DOWANOL DB | Sigma-Aldrich Chemical Company. Di(ethylene |
| | glycol) Butyl Ether. |
| Benzyl Alcohol | Sigma-Aldrich Chemical Company. |
| DOWANOL PnP | Sigma-Aldrich Chemical Company. Propylene |
| | Glycol n-Propyl Ether. |
| Phenoxy Ethyl | Sigma-Aldrich Chemical Company. |
| Alcohol | |
| 2-Ethyl Hexanal | Eastman Chemical Co. |
| Dimethyl Adipate | Sigma-Aldrich Chemical Company. |
| DOWANOL PnB | Sigma-Aldrich Chemical Company. Propylene |
| | glycol n-butyl ether. |
| ARCOSOLV DPTB | Arco Chemical Company. |
| DOWANOL PPh | Sigma-Aldrich Chemical Company. 1-Phenoxy-2- |
| | Propanol |

### Test Methods

### Tile Cleaning Procedure:

Substrate preparation:

A white vinyl composition tile (Excelon, Armstrong) was first stripped using 3M Twist'n Fill™ #6 Speed Stripper and a brown stripping floor pad. The tiles were rinsed with copius amounts of water and allowed to dry for one week at 30% RH (Relative Humidity) and 20° C. (68° F.). The tiles were then coated with 4 coats of traditional acrylic floor finish (SPANGLE, 3M Company) using surgical gauze at a rate of 49 square meters/liter (2000 sq ft/gallon). One hour was allowed for drying between coats of finish at 30% RH and 20° C. (68° F.). These tiles were then allowed to cure at 32° C. (90° F.) for one week. The tiles were stored at 30% RH and 20° C. (68° F.). The tiles were soiled as described in ASTM D 3206-87. The tiles were then subjected to the cleaning test described below with 48 hours of being soiled.

### Cleaning Solution Test:

The ready to use formulations were made at least 24 hours prior to testing. A Gardner Heavy Duty Wear Tester No. 278 (Gardner Laboratory, Bethesda Md.) was used and fitted with Easy Scrub microfiber mop media (3M Company), trimmed to fit the apparatus. The pad was first wet with water and wrung out thoroughly. One large drop of cleaning solution (0.2 milliliter) was placed on the tile and the machine was cycled 10 times. Each test formulation was tested side by side 3M Twist'n Fill™ #3 Neutral Cleaner. The tile was wiped dry with a clean paper towel. The test formulation was then rated on a 1 to 5 scale, where cleaning with just water was a 1 and complete removal was a 5. The rating was then corrected to the rating of the 3M Twist'n Fill™ #3 Neutral Cleaner to keep the ratings consistent with the commercially available reference solution.

### Examples 1-33

To form the sample compositions for Examples 1-33, the surfactants shown in Table 2 (0.45 gram) and LP-100 (0.045 gram, N-octyl pyrrolidone commercially available from ISP), were added to 500 grams of DI water and mixed. If needed, the pH was adjusted to 7.5 by using HCl or NaOH. The resulting samples were tested using the Tile Cleaning Procedure Test Method listed above. The ratings received using the Test Method are also shown in Table 2.

A commercially available neutral cleaner, available from 3M Co. under the trade name “Twist'n Fill™ 3H” was tested in the same manner and received a rating of 2.

TABLE 2

| Example | Surfactant | Rating |
|---|---|---|
| 1 | BARLOX 12 | 2 |
| 2 | DEHYPOUND ST | 2 |
| | 15 | |
| 3 | DEHYPOUND | 2 |
| | HSC 5515 | |
| 4 | EMPICOL ESA/A2 | 2 |
| 5 | GLUCOPAN 425 | 5 |
| 6 | MIRATAINE | 4 |
| | CB/M | |
| 7 | MIRACARE | 1 |
| | 2MCAS | |
| 8 | MIRACARE BC-10 | 1 |
| 9 | MIRACARE BC-20 | 1 |
| 10 | MIRACARE MHT | 2 |
| 11 | MIRACARE MP35 | 2 |
| 12 | MIRACARE MS-2 | 2 |
| 13 | MIRANOL FBS | 2 |
| 14 | MIRANOL Ultra C-32 | 1 |
| 15 | MIRAPOL SURF- | 1 |
| | S110 | |
| 16 | MIRAPON EXCEL 825 | 2 |
| 17 | MIRATAINE BET- | 3 |
| | 030 | |
| 18 | MIRATAINE CBS | 2 |
| 19 | MIRATAINE H2C- | 1 |
| | HA | |
| 20 | PLANTAREN | 5 |
| | 2000N UP | |
| 21 | RHODACAL LDS-22 | 1 |
| 22 | RHODAMOX LO | 2 |
| 23 | RHODAPON LCP | 1 |
| 24 | RHODOCLEAN | 1 |
| | ASP | |
| 25 | STANDAPOL ES-2 | 1 |
| 26 | STARFACTANT | 1 |
| | 20 | |
| 27 | STEPANOL AEM | 2 |
| 28 | TOMADOL 1-7 | 1 |
| 29 | TRITON X-35 | 1 |
| 30 | TRITON CF-32 | 1 |
| 31 | TRITON DF-12 | 1 |
| 32 | TRITON CF-76 | 2 |
| 33 | TWEEN 20 | 1 |

### Examples 34-45

### To form sample compositions Examples 34-45, alkylpolyglucoside (0.45 grams of either PLANTAREN 2000N UP or GLUCOPAN 425) and the wetting agents (0.045 grams) listed in Table 3, were added to 500 grams of DI water and mixed. If needed, the pH was adjusted to 7.5 by using HCl or NaOH. The samples were tested using the Tile Cleaning Procedure described above, and the results are also provided in Table 3.

TABLE 3

| | | Rating when | Rating when |
|---|---|---|---|
| | | PLANTAREN | GLUCOPON |
| | | 2000N UP was | 425 was |
| Example | Wetting agent | used | used |
| 34 | N-octyl pyrrolidone | 5 | 5 |
| | (LP 100) | | |
| 35 | Hexyl Carbitol | 4 | 2 |
| 36 | DOWANOL DPM | 3 | 3 |
| 37 | DOWANOL DB | 3 | 3 |
| 38 | DOWANOL PNP | 3 | 2 |
| 39 | Benzyl Alcohol | 3 | 3 |
| 40 | Phenoxy Ethyl Alcohol | 2 | 4 |
| 41 | 2-Ethyl Hexanal | 3 | 3 |
| 42 | Dimethyl Adipate | 2 | 4 |
| 43 | DOWANOL PnB | 1 | 3 |
| 44 | ARCOSOLV DPTB | 3 | 4 |
| 45 | Phenoxy-2-Propanol | 2 | 3 |

The invention has been described with reference to various embodiments and techniques. However, it will be apparent to one of ordinarily skill in the art that many variations and modifications may be made while remaining within the spirit and scope of the invention.

1. A neutral cleaning composition comprising an alkyl glucoside and an alkyl pyrrolidone, present at an actives weight ratio of at least about 2:1.

2. The cleaning composition of claim 1 wherein the composition has low odor and biodegradability.

3. The cleaning composition of claim 1, wherein the alkyl glucoside and alkyl pyrrolidone are present at an actives weight ratio of about 3:1 to about 6:1.

4. The cleaning composition of claim 1, wherein the alkyl glucoside and alkyl pyrrolidone are present at an actives weight ratio of about 4.5:1 to about 5:1.

5. The cleaning composition of claim 1, wherein the alkyl glucoside comprises a C8-C18 alkyl glucoside.

6. The cleaning composition of claim 1, wherein the alkyl glucoside comprises a C10-C16 alkyl glucoside.

7. The cleaning composition of claim 1, wherein the alkyl glucoside comprises coco glucoside.

8. The cleaning composition of claim 1, wherein the alkyl pyrrolidone comprises a C8 or higher alkyl pyrrolidone.

9. The cleaning composition of claim 1, wherein the composition is nonionic.

10. A cleaning use-composition comprising less than about 1% by weight of an alkyl glucoside and an alkyl pyrrolidone, wherein the alkyl glucoside and alkyl pyrrolidone are present at an actives weight ratio of at least about 2:1.

11. The cleaning use-composition of claim 10 comprising less than about 0.5% by weight of the alkyl glucoside and alkyl pyrrolidone.

12. The cleaning use-composition of claim 10 comprising less than about 0.2% by weight of the alkyl glucoside and alkyl pyrrolidone.

13. A method of cleaning a surface comprising:
providing a composition concentrate comprising an alkyl glucoside and an alkyl pyrrolidone, present at an actives weight ratio of at least about 2:1;
diluting the composition concentrate with water by at least 1:10 to provide a use-composition; and
applying the use-composition to the surface.

14. The method of claim 13 wherein diluting the composition concentrate comprises:
diluting the composition concentrate with water by at least 1:100 to provide the use-composition.

15. The method of claim 13 wherein diluting the composition concentrate comprises:
diluting the composition concentrate with water by at least 1:400 to provide the use-composition.

16. The method of claim 13 wherein diluting the composition concentrate comprises:
diluting the composition concentrate with water by at least 1:600 to provide the use-composition.

17. The method of claim 13 wherein diluting the composition concentrate comprises:
diluting the composition concentrate with water by at least 1:900 to provide the use-composition.
